(19) United States
(12) Patent Application Publication
(10) Pub. No.: US 2008/0065807 A1
(43) Pub. Date: Mar. 13, 2008

(54) Motherboard and electrical device with digital enhanced cordless telecommunication

(75) Inventors: Tian-Sen Wu, (US); Yung-Lang Huang, (US); Feng-Shin Lin, (US)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/808,482

(22) Filed: Jun. 11, 2007

(30) Foreign Application Priority Data
Sep. 12, 2006 (TW) 095133736

(51) Int. Cl. G06F 13/20

(52) U.S. Cl. 710/313

(57) ABSTRACT

A motherboard includes a digital enhanced cordless telecommunication (DECT) circuit, a bus, and a data processing circuit. The DECT circuit receives a wireless signal to output data. The bus is electrically connected to the DECT circuit to transfer the data. The data processing circuit is electrically connected to the bus to receive the data and performs an operation on the data.

### BACKGROUND OF THE INVENTION

1. Field of the Invention

The invention relates to a motherboard and an electronic device and, more particularly, to a motherboard and an electronic device with a cordless telecommunication circuit.

2. Description of the Related Art

Wireless communication technology has been used in many kinds of electronic devices, such as a mobile phone, a digital enhanced cordless telecommunication (DECT) phone, a wireless network or a personal computer peripheral device.

FIG. 1 is a schematic diagram showing a conventional personal computer 1 assembled with a set of cordless earphones 2. As shown in FIG. 1, the personal computer 1 includes a main body 11 and a display 12, wherein the main body 11 has a RJ-45 port 111 and a universal serial bus (USB) port 112. When users insert a network line 3 in the RJ-45 port 111, the main body 111 may be connected with Internet 4 using Asymmetrical Digital Subscriber Loop (ADSL) or Ethernet through the RJ-45 port 111 and the network line 3. Furthermore, the set of cordless earphones 2 includes a base station 21 and an earphone 22 with a microphone, wherein the base station 21 has a USB port 211. A user may use a USB connecter 5 to connect the USB port 112 of the main body 11 with the USB port 211 of the base station 21, so that the user can use the earphone 22 and the main body 11 to make an internet phone call or use other instant message applications.

Generally speaking, the earphone 22 mostly communicates with the base station 21 using the Bluetooth protocol. However, since the effective communication range of the Bluetooth system is too short, a user can not use the earphone 22 far away from the base station 21.

Furthermore, because the base station 21 is connected with the main body 11 through USB, it is inconvenient for a user to use it. When the main body 11 is a mobile device, such as a notebook computer or a personal digital assistant (PDA), the base station 21 is even more cumbersome.

Therefore, how to provide a motherboard or an electronic device without above problems has become an urgent issue to be solved.

### SUMMARY OF THE INVENTION

In view of the issue mentioned above, an objective of the invention is to provide a motherboard and an electronic device, which are integrated with digital enhanced cordless telecommunication (DECT) circuits.

To achieve the above objectives, a motherboard according to the invention comprises a DECT circuit, a bus and a data processing circuit. The DECT circuit receives a wireless signal to output data. The bus is electrically connected to the DECT circuit to transfer the data. The data processing circuit is electrically connected to the bus to receive the data and performs an operation on the data.

To achieve the above objectives, an electronic device according to the invention comprises a motherboard and an output/input unit. The motherboard includes a DECT circuit, a bus and a data processing circuit, wherein the DECT circuit receives a wireless signal to output data, the bus is electrically connected to the DECT circuit to transfer the data, the data processing circuit is electrically connected to the bus to receive the data and performs an operation on the data, and the output/input unit is electrically connected to the data processing circuit to process the data.

To sum up, because the motherboard and the electronic device according to the invention are integrated with a DECT circuit, they can provide wireless communication services with a larger range without unnecessary base stations, and therefore the electronic device is more light, electricity-saving and high anti-noise.

### BRIEF DESCRIPTION OF THE DRAWINGS

FIG. 1 is a schematic diagram showing a conventional personal computer assembled with a set of cordless earphones.

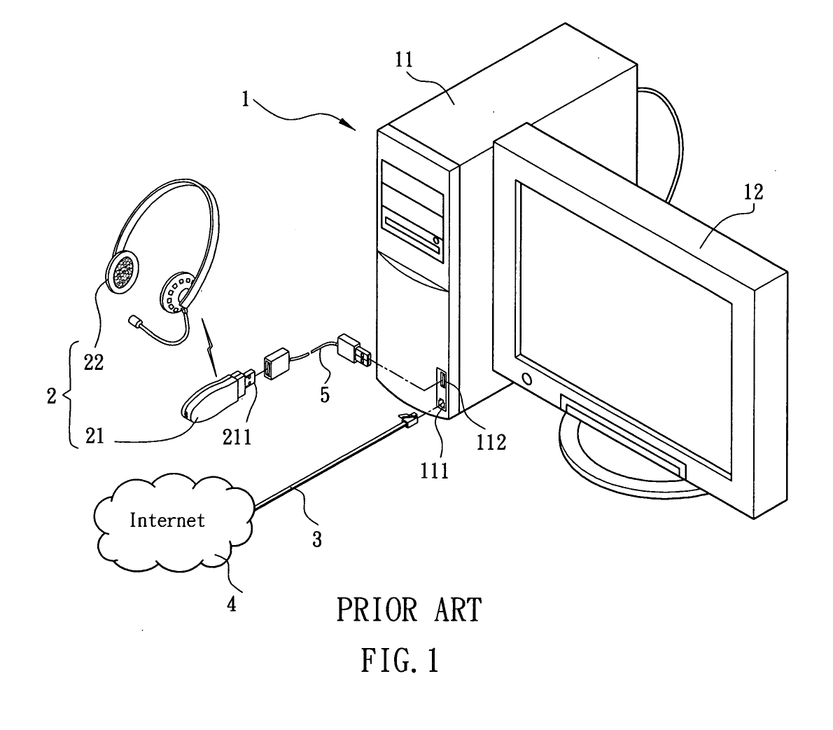

FIG. 2 is a schematic diagram showing an electronic device according to one preferred embodiment of the invention.

### DETAILED DESCRIPTION OF THE PREFERRED EMBODIMENT

The motherboard and the electronic device according to one preferred embodiment of the invention will be described below with reference to accompany drawings.

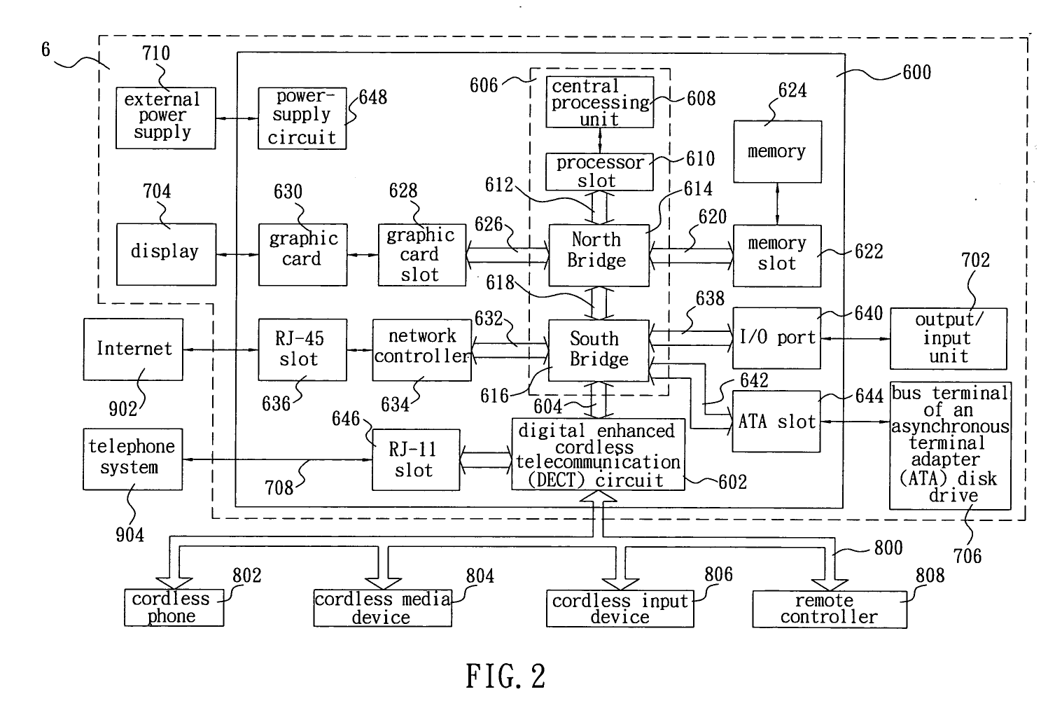

FIG. 2 is the schematic diagram showing an electronic device 6 according to one preferred embodiment of the invention. As shown in FIG. 2, the electronic device 6 includes a motherboard 600 and an output/input unit 702, wherein the motherboard 600 includes a digital enhanced cordless telecommunication (DECT) circuit 602, a bus 604, and a data processing circuit 606.

In the embodiment, the DECT circuit 602 receives a wireless signal 800 from at least one of cordless devices, such as a cordless phone 802, a cordless media device 804, a cordless input device 806, or a remote controller 808, and further output data. In addition, the bus 604 is respectively electrically connected to the DECT circuit 602 and the data processing circuit 606. Data output from the DECT circuit 602 is transferred to the data processing circuit 606 through the bus 604 for data processing. Furthermore, the output/input unit 702 is electrically connected to the data processing circuit 606, and therefore users may use the data through the output/input unit 702.

Herein, the DECT circuit 602, the bus 604 and the data processing circuit 606 are directly integrated with the motherboard 600, and the bus 604 is provided on the motherboard 600. Therefore, the DECT circuit 602 needs not additional connecters to connect with the circuit of the motherboard 600.

Furthermore, in the embodiment, the electronic device 6 may be a personal computer, a notebook computer or a barebone.

In addition, further referring to FIG. 2, the data processing circuit 606 includes a central processing unit 608, a North Bridge 614 and a South Bridge 616. The central processing unit 608 is provided at a processor slot 610, and connected with the North Bridge 614 through a front bus 612. The North Bridge 614 is connected with the South Bridge 616 through a bus 618. Therefore, the North Bridge 614 is mainly connected with high-speed devices (the central processing unit 608 and the memory), and the South Bridge 616 is mainly connected with low-speed peripheral devices.

Moreover, the motherboard 600 further includes a memory 624, a graphic card 630, a network controller 634 and an I/O port 640. The memory 624 is provided at a memory slot 622, and connected with the North Bridge 614 through a memory bus 620. The graphic card 630 is disposed at a graphic card slot 628, and is connected with the North Bridge 614 through a graphic card bus 626. The output port of the graphic card 630 is connected with a display 704 for displaying graphics through a display line.

Furthermore, the I/O port 640 is connected with the South Bridge 616 through the circuit 638 on the motherboard 600. The terminal of the output/input unit 702 is inserted in the I/O port 640 to provide an input function for the system of the motherboard 600 and thereby be the input interface for users operating electronic devices.

Otherwise, the network controller 634 is connected with the South Bridge 616 through a peripheral bus 632, and is connected with a RJ-45 slot 636 to connect to Internet 902 to provide a network connection function for the system of the motherboard 600. A bus terminal of an asynchronous terminal adapter (ATA) disk drive 706 is inserted in an ATA slot 644, and is connected with the South Bridge 616 through an ATA bus 642.

Furthermore, the DECT circuit 602 is connected with the South Bridge 616 through the bus 604. The South Bridge 616 supports various kinds of peripheral interfaces, and in view of these peripheral interfaces, the bus 604 may be a universal serial bus (USB), an IEEE 1394 bus, a peripheral component interconnect extended (PCI-X) bus, or PCI-EXPRESS bus.

Moreover, further referring to FIG. 2, the DECT circuit 602 may be connected to a RJ-11 slot 646, and a plug of a telephone line 708 may be inserted in the RJ-11 slot 646 to link the DECT circuit 602 and a telephone system 904.

In addition, the motherboard 600 further comprises an external power supply 710 connected with a power-supply circuit 648 to provide power to the motherboard 600, and the DECT circuit 602 may obtain power from the motherboard 600.

In the embodiment, the DECT circuit 602 communicates with other cordless electronic devices, such as the cordless phone 802, the cordless media device 804, the cordless input device 806 or the remote controller 808, through the wireless signal 800 using the DECT protocol.

The major difference between the DECT protocol and the traditional analog wireless protocol is that the farthest communication range of the DECT protocol indoor is 50 meters and 300 meters outdoor, and the DECT protocol can avoid interference of other radio waves.

Moreover, a cordless electronic device may be the cordless phone 802, and users can use the cordless phone 802 hold in hand to communicate with the DECT circuit 602, or dial a room telephone to be connected with the telephone system 904, through the DECT circuit 602, RJ-11 slot 646 and the telephone line 708.

Furthermore, users also use a cordless electronic device, such as the cordless phone 802, to dial an internet phone, such as a voice over internet protocol (VoIP) phone, and connect with the internet phone server of Internet 902 through the network line of the motherboard 600. Besides, a cordless electronic device, such as the cordless phone 802, is also used in network instant messages for conversation.

Therefore, the cordless media device 804 may be a cordless earphone, a cordless microphone, or an integrated device with a cordless earphone and a cordless microphone. Users can use the cordless media device 804 to provide voice input or receiving voice for the system comprised of the motherboard 600. The cordless media device 804 is also used in an internet phone or network instant messages for conversation.

In addition, when the electronic device 6 is a multimedia center or a digital household appliance, users may use the remote controller 808 to control the electronic device 6 operating.

To sum up, because the motherboard and the electronic device according to the invention are integrated with a DECT circuit, the motherboard and the electronic device can provide larger range of wireless communications without unnecessary base stations, and therefore the electronic device is light, power-saving and noise-resistant.

Although the invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A motherboard, comprising:
a digital enhanced cordless telecommunication (DECT) circuit for receiving a wireless signal and outputting data;
a bus electrically connected to the DECT circuit for transferring the data; and
a data processing circuit electrically connected to the bus to receive the data and performing an operation on the data.

2. The motherboard according to claim 1, wherein the bus is a universal serial bus (USB), an IEEE 1394 bus, a peripheral component interconnect extended (PCI-X) bus, or PCI-EXPRESS bus.

3. The motherboard according to claim 1, wherein the data processing circuit comprising:
a central processing unit; and
a system chipset electrically connected to the bus and the central processing unit to transfer the data through the DECT circuit to the central processing unit to perform the operation.

4. The motherboard according to claim 1, wherein the motherboard is used in a personal computer, a notebook computer, a barebone, a multimedia center, or a digital household appliance.

5. The motherboard according to claim 1, wherein the DECT circuit communicates with a cordless electronic device using DECT protocol.

6. The motherboard according to claim 5, wherein the cordless electronic device is a cordless input device, a remote controller, a cordless telephone, a cordless earphone, a cordless microphone, or a cordless earphone integrated with a cordless microphone.

7. The motherboard according to claim 1, further comprising:
a power-supply circuit electrically connected to the DECT circuit to provide electric power.

8. An electronic device, comprising:
a motherboard comprising a digital enhanced cordless telecommunication (DECT) circuit, a bus and a data processing circuit, wherein the DECT circuit receives a wireless signal to output data, the bus is electrically connected to the DECT circuit to transfer the data, and the data processing circuit is electrically connected to the bus to receive the data and performs an operation on the data; and
an output/input unit electrically connected to the data processing circuit to process the data.

9. The electronic device according to claim 8, wherein the bus is a universal serial bus (USB), an IEEE 1394 bus, a peripheral component interconnect extended (PCI-X) bus, or PCI-EXPRESS bus.

10. The electronic device according to claim 8, wherein the data processing circuit comprising:
a central processing unit; and
a system chipset electrically connected to the bus and the central processing unit to transfer the data through the DECT circuit to the central processing unit to perform an operation.

11. The electronic device according to claim 8, wherein the electronic device is a personal computer, a notebook computer, a barebone, a multimedia center 6r, a digital household appliance.

12. The electronic device according to claim 8, wherein the DECT circuit communicates with a cordless electronic device using DECT protocol.

13. The electronic device according to claim 12, wherein the cordless electronic device is a cordless input device, a remote controller, a cordless telephone, a cordless earphone, a cordless microphone, or a cordless earphone integrated with a cordless microphone.

14. The electronic device according to claim 8, wherein the motherboard further comprises a power-supply circuit electrically connected to the DECT circuit to provide electric power.
